(19) United States
(12) Patent Application Publication
(10) Pub. No.: US 2023/0286245 A1
(43) Pub. Date: Sep. 14, 2023

(54) HONEYCOMB STRUCTURE HAVING IMPROVED THERMAL CONDUCTIVITY

(71) Applicant: Airbus Operations SAS, TOULOUSE (FR)

(72) Inventors: Laurent CALIMAN, TOULOUSE (FR); Florian RAVISE, TOULOUSE (FR); Michael BELIN, TOULOUSE (FR)

(21) Appl. No.: 18/180,291

(22) Filed: Mar. 8, 2023

(30) Foreign Application Priority Data
Mar. 10, 2022 (FR) 2202097

(51) Int. Cl. B32B 3/12; B32B 3/28; B32B 27/34; B32B 37/18; B32B 38/08; B32B 37/12; B32B 27/08

(52) U.S. Cl. CPC B32B 3/12; B32B 3/28; B32B 27/34; B32B 37/18; B32B 38/08; B32B 37/12; B32B 27/08; B32B 2307/304; B32B 2260/046; B32B 2260/028; B32B 2264/105; B32B 2305/07

(57) ABSTRACT

A honeycomb structure has a core made up of a plurality of corrugated sheets which are superposed and fixed together. The corrugated sheets are made from a thermally insulating material. The corrugated sheets are impregnated with a resin filled with thermally conductive powder along their entire length. The honeycomb structure can be used when the ambient temperature exceeds, for example, 120° C.

### CROSS-REFERENCES TO RELATED APPLICATIONS

This application claims the benefit of the French patent application No. 2202097 filed on Mar. 10, 2022, the entire disclosures of which are incorporated herein by way of reference.

### FIELD OF THE INVENTION

The present invention relates to the general field of honeycomb structures and more particularly to honeycomb structures having improved thermal conductivity. The present invention also relates to different methods for manufacturing such a honeycomb structure.

### BACKGROUND OF THE INVENTION

In various fields, it is necessary to attenuate noise, for example for an aircraft engine. It is thus known to use an acoustically absorbent material disposed around the source of noise in order to attenuate it.

An acoustically absorbent material takes for example the form of a honeycomb structure 100, as shown in FIG. 1, which has a resistive skin 102 in which holes 103 are created, a bottom skin 104 and cells 106 which are juxtaposed with one another and which have a hexagonal cross section here. The cells 106 are disposed between the resistive skin 102 and the bottom skin 104.

The resistive skin 102 is oriented towards the source of noise and the holes 103 allow the sound waves to enter the cavities formed by the cells 106.

When the ambient temperature is greater than 120° C., such a honeycomb structure 100 needs to have heat transfer capabilities. In these cases, the cells 106 are made of metal (aluminium) and the honeycomb structure 100 then has, for each skin 102, 104, a glass ply 108a-b which is positioned between the cells 106 and the resistive skin 102 on one side and the bottom skin 104 on the other side in order to provide anti-corrosion protection.

Although such a structure yields good results, it is relatively heavy on account of the presence of the metal cells and the glass plies and it is therefore necessary to find an alternative to this type of structure.

### SUMMARY OF THE INVENTION

An object of the present invention is to propose a honeycomb structure which has improved thermal conductivity.

To this end, a honeycomb structure is proposed, having a core made up of a plurality of corrugated sheets which are superposed and fixed together, wherein said corrugated sheets are made from a thermally insulating material, wherein said corrugated sheets are impregnated with a resin filled with thermally conductive powder along their entire length.

With such an arrangement, such a honeycomb structure can be used even if the ambient temperature exceeds certain thresholds, for example 120° C.

Advantageously, the thermally insulating material is an aramid paper.

Advantageously, the thermally conductive powder is a metal powder.

The invention also proposes a method for manufacturing a honeycomb structure according to one of the above variants, said method comprising:
a provision step during which a sheet is provided,
a shaping step during which said sheet is shaped into the form of a corrugated sheet,
a stacking and fixing step during which said corrugated sheet is fixed to a similar corrugated sheet obtained during a preceding cycle,
a step of returning to the provision step until a stack of the desired number of sheets is obtained,
an impregnating step during which the stack of sheets thus obtained is entirely impregnated with a phenolic resin filled with thermally conductive powder, and
a polymerizing step during which the phenolic resin is polymerized.

The invention also proposes a method for manufacturing a honeycomb structure according to one of the above variants, said method comprising:
a provision step during which a sheet is provided,
an impregnating step during which the sheet thus provided is entirely impregnated with a thermoplastic resin filled with thermally conductive powder,
a consolidating step during which the sheet thus impregnated is consolidated to yield an impregnated sheet,
a shaping step during which said impregnated sheet is shaped into the form of a corrugated sheet,
a stacking and fixing step during which said corrugated sheet is fixed to a similar corrugated sheet obtained during a preceding cycle,
a step of returning to the provision step until a stack of the desired number of sheets is obtained, and
a polymerizing step during which the thermoplastic resin is polymerized.

The invention also proposes a method for manufacturing a honeycomb structure according to one of the above variants, said method comprising:
a provision step during which a sheet to be fixed is provided,
a stacking and fixing step during which said sheet to be fixed is fixed to a similar sheet to be fixed obtained during a preceding cycle,
a step of returning to the provision step until a stack of the desired number of sheets is obtained,
a stretching step during which the stack of sheets thus obtained is stretched parallel to the stacking direction in order to shape the sheets of the stack into the form of corrugated sheets,
an impregnating step during which the stack of sheets thus obtained is entirely impregnated with a phenolic resin filled with thermally conductive powder, and
a polymerizing step during which the phenolic resin is polymerized.

Advantageously, the manufacturing method has, before the stacking and fixing step, a glue application step during which glue is applied to the fixing surfaces of the sheets.

### BRIEF DESCRIPTION OF THE DRAWINGS

The features of the invention mentioned above, along with others, will become more clearly apparent upon reading the following description of an exemplary embodiment, said description being given with reference to the appended drawings, in which:

FIG. 1 is a perspective view of a honeycomb structure of the prior art,

FIG. 2 is a perspective view of a honeycomb structure according to the invention,

FIG. 3 is a perspective view of a corrugated shape forming a core of the honeycomb structure,

FIG. 4 is a schematic depiction of the steps of a first method for manufacturing the honeycomb structure according to the invention,

FIG. 5 is a schematic depiction of the steps of a second method for manufacturing the honeycomb structure according to the invention, and

FIG. 6 is a schematic depiction of the steps of a third method for manufacturing the honeycomb structure according to the invention.

### DETAILED DESCRIPTION OF THE PREFERRED EMBODIMENTS

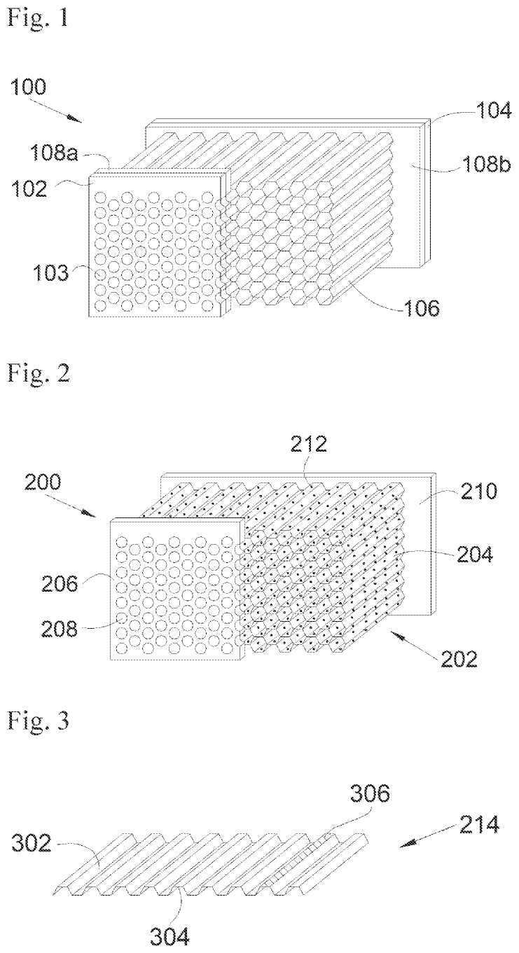

FIG. 2 shows a honeycomb structure 200 according to the invention, which has a core 202 made up of cells 204 that are juxtaposed with one another and have a hexagonal cross section.

The core 202 is made up of a plurality corrugated sheets 214 which are superposed and fixed together and an example of which is shown in FIG. 3.

Each corrugation has a trapezoidal cross section with, alternately, a first corrugation 302 which is open at the large base of the trapezium on a first side of the corrugated sheet 214, in this case at the top, and a second corrugation 304 which is open at the large base of the trapezium on a second side of the corrugated sheet 214, in this case at the bottom. When two corrugated sheets 214 are fixed together, they are offset with respect to one another such that a first corrugation of the lower corrugated sheet 214 is faces a second corrugation of the upper corrugated sheet 214 so as to create the cells 204 of hexagonal cross section between the two corrugated sheets 214 fixed in this way.

The two corrugated sheets 214 are fixed along a fixing surface 306 which corresponds to the small base of the trapezium, which is also referred to as “node”. According to one embodiment, the fixing involves adhesively bonding the fixing surfaces 306 together and according to another embodiment, the fixing involves welding the fixing surfaces 306 together.

In the embodiment of the invention presented in FIG. 2, the honeycomb structure 200 has a resistive skin 206 in which holes 208 are created and a bottom skin 210 which are fixed on either side of the core 202 at the ends of the cells 204.

The core 202 and the cells 204 are thus disposed between the resistive skin 206 and the bottom skin 210.

The resistive skin 206 is intended to be oriented towards a source of noise such that the sound waves pass into the cells 106 by passing through the holes 208.

The cells 204 and therefore the corrugated sheets 214 are made from a thermally insulating material, for example a paper, that is to say a non-woven and porous element or a woven element, for example an aromatic polyamide, referred to as aramid paper which may be non-woven and porous or woven.

The skins 206 and 210 may take the form of a thermosetting, thermoplastic or hybrid element, as in the case of the prior art.

To improve the thermal conductivity of the core 202, the corrugated sheets 214 are impregnated with a resin filled with thermally conductive powder, for example metal powder such as aluminium or aluminium oxide (known as alumina) powder, or such as copper or bronze powder. Depending on the filler used, the electrical conductivity of the core 202 may also be improved. The thermally conductive powder is depicted by way of the dots 212.

The resin is for example a phenolic or thermoplastic resin.

Each corrugated sheet 214 extends parallel to the corrugations 302 and 304 between two ends, wherein a first end is secured to the resistive skin 206 and a second end is secured to the bottom skin 210.

The resin thus filled is impregnated along the entire length of the corrugated sheets 214 and of the cells 204, that is to say between the two ends and the two skins 206 and 210. The presence of the thermally conductive filler in the core 202 makes the latter thermally conductive and it can then be used for applications in which the ambient temperature exceeds certain thresholds, for example 120° C.

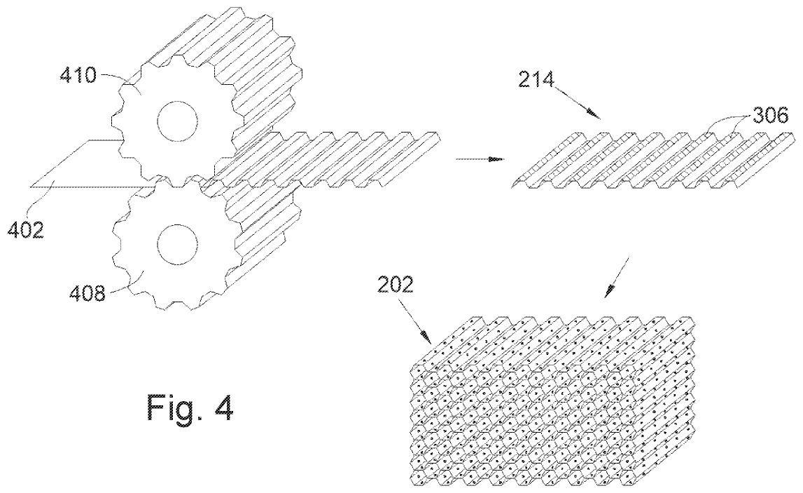

FIG. 4 shows a first method for manufacturing the core 202, each cell 204 of which has a hexagonal cross section.

The first manufacturing method comprises:
a provision step during which a sheet 402, in particular a sheet of non-woven and porous or woven aramid paper, is provided,
a shaping step during which said sheet 402 is shaped into the form of a corrugated sheet 214, such as the one described with reference to FIG. 3, the sheet 402 being able to be in the form of a sheet or of a roll to be cut following shaping,
a stacking and fixing step during which said corrugated sheet 214 is fixed to a similar corrugated sheet 214 obtained during a preceding cycle, the fixing being effected via the fixing surfaces 306,
a step of returning to the provision step until a stack of the desired number of sheets is obtained,
an impregnating step during which the stack of sheets thus obtained is entirely impregnated with a phenolic resin filled with thermally conductive powder, and
a polymerizing step during which the phenolic resin is polymerized in order to obtain the core 202.

The shaping step is carried out for example by passing the sheet 402 between two rotating rollers 408 and 410 that each have impressions in their periphery. Thus, during the passage of the sheet 402 between the two rollers 408 and 410, the impressions in said rollers 408 and 410 deform the sheet 402 so as to form the corrugations 302 and 304.

The impregnating step is carried out for example by dipping the stack of corrugated and fixed sheets entirely in a bath of filled phenolic resin in the form of a fluid.

In the case of adhesive bonding, the polymerizing step makes it possible to also polymerize the glue.

The polymerizing step depends on the phenolic resin and, in the case of adhesive bonding, on the glue used and uses the features recommended for said phenolic resin and said glue, in particular at a temperature of around 180° C.

In the case of adhesive bonding, the manufacturing method has, before the stacking and fixing step, a glue application step during which glue is applied to the fixing surfaces 306 of said corrugated sheet 214.

In the case of welding, the latter is carried out during the stacking and fixing step.

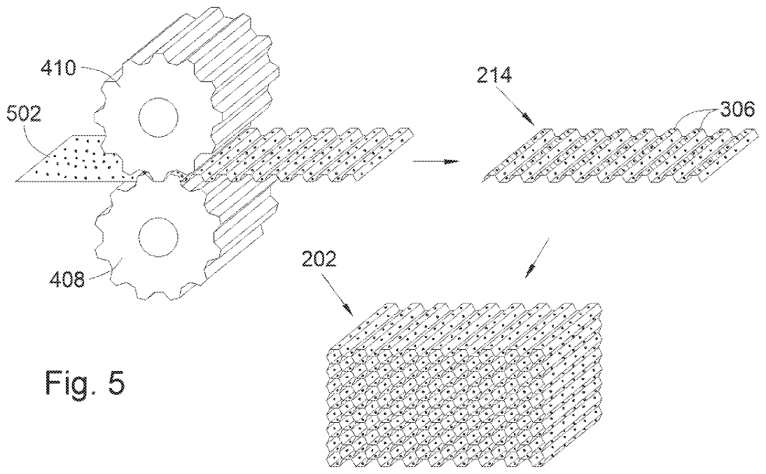

FIG. 5 shows a second method for manufacturing the core 202, each cell 204 of which has a hexagonal cross section.

The second manufacturing method comprises:
a provision step during which a sheet, in particular a sheet of non-woven and porous or woven aramid paper, is provided,
an impregnating step during which the sheet thus provided is entirely impregnated with a thermoplastic resin filled with thermally conductive powder,
a consolidating step during which the sheet thus impregnated is consolidated to yield an impregnated sheet 502,
a shaping step during which said impregnated sheet 502 is shaped into the form of a corrugated sheet 214 which takes the same form as that described with reference to FIG. 3 but in which the sheet is impregnated and consolidated,
a stacking and fixing step during which said corrugated sheet 214 is fixed to a similar corrugated sheet 214 obtained during a preceding cycle, the fixing being effected via the fixing surfaces 306,
a step of returning to the provision step until a stack of the desired number of sheets is obtained, and
a polymerizing step during which the thermoplastic resin is polymerized in order to obtain the core 202, in particular at a temperature of around 180° C.

The impregnating step is carried out for example by dipping the sheet entirely in a bath of filled thermoplastic resin in the form of a fluid.

The consolidating step consists of polymerization of the thermoplastic resin in particular a temperature lower than 400° C.

The shaping step is carried out for example by passing the impregnated sheet 502 between two rotating rollers 408 and 410 that each have impressions in their periphery. Thus, during the passage of the impregnated sheet 502 between the two rollers 408 and 410, the impressions in said rollers 408 and 410 deform the impregnated sheet 502 so as to form the corrugations 302 and 304. An increase in temperature of the impregnated and consolidated sheet in order to soften it during the shaping step makes it easier to create the corrugations.

In the case of adhesive bonding, the polymerizing step makes it possible to also polymerize the glue.

The polymerizing step depends on the thermoplastic resin and, in the case of adhesive bonding, on the glue used and uses the features recommended for said thermoplastic resin and said glue.

In the case of adhesive bonding, the manufacturing method has, before the stacking and fixing step, a glue application step during which glue is applied to the fixing surfaces 306 of said corrugated sheet 214.

In the case of welding, the latter is carried out during the stacking and fixing step.

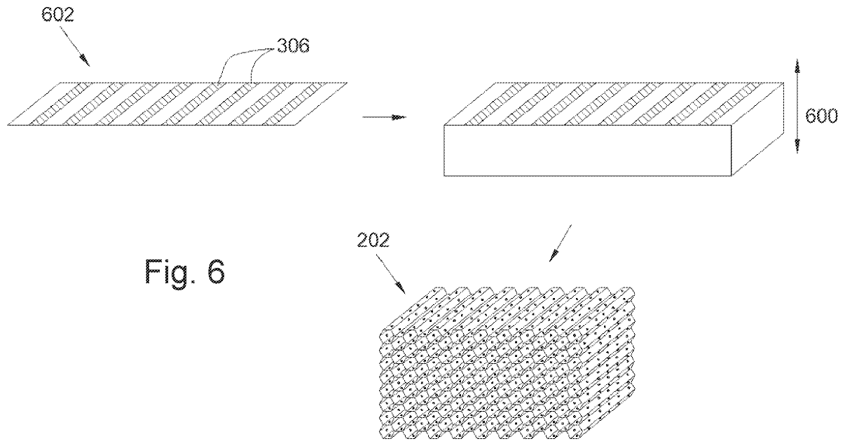

FIG. 6 shows a third method for manufacturing the core 202, each cell 204 of which has a hexagonal cross section.

The third manufacturing method comprises:
a provision step during which a sheet 602 to be fixed, in particular a sheet of non-woven and porous or woven aramid paper, is provided, the sheet 602 to be fixed being able to be in the form of a sheet or of a roll to be cut following the provision step,
a stacking and fixing step during which said sheet 602 to be fixed is fixed to a similar sheet 602 to be fixed obtained during a preceding cycle, the fixing being effected via the fixing surfaces 306,
a step of returning to the provision step until a stack of the desired number of sheets is obtained,
a stretching step during which the stack of sheets thus obtained is stretched (double-headed arrow 604) parallel to the stacking direction in order to shape the sheets of the stack into the form of corrugated sheets 214 such as the one described with reference to FIG. 3,
an impregnating step during which the stack of sheets thus obtained is entirely impregnated with a phenolic resin filled with thermally conductive powder, and
a polymerizing step during which the phenolic resin is polymerized in order to obtain the core 202, in particular at a temperature of around 180° C.

The impregnating step is carried out for example by dipping the corrugated and fixed sheets entirely in a bath of filled phenolic resin in the form of a fluid.

In the case of adhesive bonding, the polymerizing step makes it possible to also polymerize the glue.

The polymerizing step depends on the phenolic resin and, in the case of adhesive bonding, on the glue used and uses the features recommended for said phenolic resin and said glue.

In the case of adhesive bonding, the manufacturing method has, before the stacking and fixing step, a glue application step during which glue is applied to the fixing surfaces 306 of said sheet 602 to be fixed.

In the case of welding, the latter is carried out during the stacking and fixing step.

After the core 202 has been produced, the skins 206 and 210 are fixed at the ends of the cells 204 by any means known to a person skilled in the art, for example by adhesive bonding.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A honeycomb structure having a core made up of a plurality of corrugated sheets which are superposed and fixed together, wherein said corrugated sheets are made from a thermally insulating material, wherein said corrugated sheets are impregnated with a resin filled with thermally conductive powder along their entire length.

2. The honeycomb structure according to claim 1, wherein the thermally insulating material is an aramid paper.

3. The honeycomb structure according to claim 1, wherein the thermally conductive powder is a metal powder.

4. A method for manufacturing a honeycomb structure according to claim 1, said method comprising:
a provision step during which a sheet is provided;
a shaping step during which said sheet is shaped into the form of a corrugated sheet;
a stacking and fixing step during which said corrugated sheet is fixed to a similar corrugated sheet obtained during a preceding cycle;
a step of returning to the provision step until a stack of the desired number of sheets is obtained;
an impregnating step during which the stack of sheets thus obtained is entirely impregnated with a phenolic resin filled with thermally conductive powder; and
a polymerizing step during which the phenolic resin is polymerized.

5. A method for manufacturing a honeycomb structure according to claim 1, said method comprising:
a provision step during which a sheet is provided;
an impregnating step during which the sheet thus provided is entirely impregnated with a thermoplastic resin filled with thermally conductive powder;
a consolidating step during which the sheet thus impregnated is consolidated to yield an impregnated sheet;
a shaping step during which said impregnated sheet is shaped into the form of a corrugated sheet;
a stacking and fixing step during which said corrugated sheet is fixed to a similar corrugated sheet obtained during a preceding cycle;
a step of returning to the provision step until a stack of the desired number of sheets is obtained; and
a polymerizing step during which the thermoplastic resin is polymerized.

6. A method for manufacturing a honeycomb structure according to claim 1, said method comprising:
a provision step during which a sheet to be fixed is provided;
a stacking and fixing step during which said sheet to be fixed is fixed to a similar sheet to be fixed obtained during a preceding cycle;
a step of returning to the provision step until a stack of the desired number of sheets is obtained;
a stretching step during which the stack of sheets thus obtained is stretched parallel to the stacking direction in order to shape the sheets of the stack into the form of corrugated sheets;
an impregnating step during which the stack of sheets thus obtained is entirely impregnated with a phenolic resin filled with thermally conductive powder; and
a polymerizing step during which the phenolic resin is polymerized.

7. A manufacturing method according to claim 4 wherein it has, before the stacking and fixing step, a glue application step during which glue is applied to the fixing surfaces of the sheets.

8. A manufacturing method according to claim 5 wherein it has, before the stacking and fixing step, a glue application step during which glue is applied to the fixing surfaces of the sheets.

9. A manufacturing method according to claim 6 wherein it has, before the stacking and fixing step, a glue application step during which glue is applied to the fixing surfaces of the sheets
